(19) United States
(12) Patent Application Publication
(10) Pub. No.: US 2020/0116643 A1
(43) Pub. Date: Apr. 16, 2020

(54) DEVICE FOR CALIBRATING A SPECTROMETER

(71) Applicant: Rigaku Analytical Devices, Inc., Wilmington, MA (US)

(72) Inventors: Stevan Kun, Worcester, MI (US); Kenneth J. Vachon, JR., Holliston, MA (US); John Thomas Wiesemann, Somerville, MA (US)

(21) Appl. No.: 16/157,525

(22) Filed: Oct. 11, 2018

(51) Int. Cl. G01N 21/71; G01J 3/42; H01S 3/00; G01J 3/02

(52) U.S. Cl. CPC G01N 21/718; G01J 3/42; G01J 2003/2866; G01J 3/0291; G01J 2003/423; H01S 3/0085

(57) ABSTRACT

A device for analyzing the material composition of an object via plasma spectrum analysis, using a self-calibrating spectrometer, may include a laser assembly configured to emit a beam for sample plasma excitation, an optical assembly configured to direct the laser beam towards the target, and to collect the plasma light and guide it to the spectrometer sensor for target's plasma spectrum analysis, and a calibration light source configured to emit light with discrete and stable spectral lines. The calibration light source is preferably incorporated in the optical assembly. The optical assembly is configured to provide a primary optical path and a secondary optical path; the primary optical path directs light emitted from a plasma to the spectrometer, the secondary optical path directs light from the calibration light source to the spectrometer. The device may also include a housing that substantially encloses the laser assembly and the optical assembly.

### BACKGROUND

### 1. Field of the Invention

The present invention generally relates to handheld and portable spectroscopy systems and their calibration systems. A preferred example of the application of the innovation is in the area of Laser-induced breakdown spectroscopy.

### 2. Description of Related Art

Laser-induced breakdown spectroscopy (“LIBS”) is a type of atomic emission spectroscopy which uses a high energy laser pulse as the excitation source. The laser beam is focused onto a sample, on which then plasma forms, which atomizes and excites the material of the sample. In principle, LIBS can analyze any matter regardless of its physical state, be it solid, liquid, or gas. Because all elements emit light of characteristic frequencies when excited to sufficiently high temperatures, LIBS can detect all elements, limited only by the power of the laser beam utilized as well as the sensitivity and wavelength range of the spectrograph and sensor.

Once the constituents of the analyzed material are determined, LIBS may also be used to evaluate the relative abundance of each constituent element or to monitor the presence of impurities. In practice, detection limits are a function of a) the plasma excitation temperature, b) the light collection window, c) the line strength of the viewed transition, and d) accuracy of the spectrometer calibration.

LIBS devices operate by focusing the laser beam onto a small area at the surface of the sample. When the laser beam is discharged, it ablates a very small amount of material, in the range of nanograms to picograms, which generates a plasma plume with temperatures in excess of 100,000 K. At these high temperatures during the early plasma, the ablated material dissociates (breaks down) into excited ionic and atomic species. During this time, the plasma emits a continuum of radiation which does not contain any useful information about the species present. However, the plasma expands at supersonic velocities and within a very small timeframe (order of microseconds), cools to 5,000-20,000 K. At this point, the characteristic atomic emission lines of the elements can be observed, and spectra are acquired.

Spectrometer sensors typically contain several thousand pixels. In order to achieve accurate operation, the spectrometer and the spectrometer sensor must be calibrated: we have to know to which wavelength each sensor pixel corresponds. This has to be up-to-date—for the time when each spectrum is acquired. Bad calibration results in misidentification of constituents. If the calibration is inaccurate, the spectrometer is at least useless, and it can even be dangerous (if it misidentifies hazardous substances as non-hazardous).

The calibration is a three-step process: 1) a calibration spectrum is recorded with the instrument; this spectrum containing stable spectral peaks at known wavelengths, 2) each spectral peak is identified by its spectrometer pixel position, 3) the sensor pixel locations of spectral peaks extracted from the recorded calibrator spectrum are correlated with their corresponding wavelengths as published in literature.

Once calibrated, spectrometers do not maintain their calibrations forever. Portable, battery-operated spectrometers are especially susceptible to deterioration of calibration due to mechanical shocks, temperature variations, and field environment. Therefore, periodical recalibration of the spectrometer is necessary. Automated self-calibration that is performed as frequently as needed without requiring assistance from the operator is required to ensure that portable, handheld, battery-operated spectrometers always operate within their specifications.

### SUMMARY

A device for analyzing the material composition of an object via plasma spectrum analysis, using a self-calibrating spectrometer, may include a laser assembly configured to emit a beam for sample plasma excitation, an optical assembly configured to direct the laser beam towards the target, and to collect the plasma light and guide it to the spectrometer sensor for target's plasma spectrum analysis, and a calibration light source configured to emit light with discrete and stable spectral lines. The calibration light source is preferably incorporated in the optical assembly. The optical assembly is configured to provide a primary optical path and a secondary optical path; the primary optical path directs light emitted from a plasma to the spectrometer, the secondary optical path directs light from the calibration light source to the spectrometer.

The device may also include a housing that substantially encloses the laser assembly and the optical assembly. The housing defines at least one opening configured to allow the beam to travel from the optical assembly to the target and to allow the plasma emitted light to be collected by the optical assembly.

The device may also include a control system being configured to switch between a measurement mode and a calibration mode. In the calibration mode, the control system is configured to turn on the calibration light source, identify the position of at least one known discrete spectral line of the calibration spectrum on the spectrometer sensor, recalculate and update the corresponding wavelength of at least one sensor pixel, resulting in an updated spectrometer sensor calibration. The updated calibration can be used retroactively to recalculate already recorded spectra, and/or proactively for future analysis.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of a system for analyzing the material composition of an object via plasma spectrum analysis;

FIG. 2A illustrates a block diagram of the internal components of the system while in a measurement mode for analyzing the material composition of an object via plasma spectrum analysis of FIG. 1;

FIG. 2B illustrates a block diagram of the internal components of the system for analyzing the material composition of an object via plasma spectrum analysis of FIG. 1, while in a spectrometer calibration mode; and

FIG. 3 illustrates a block diagram of a laser assembly for use with the system for analyzing the material composition of an object via plasma spectrum analysis.

### DETAILED DESCRIPTION

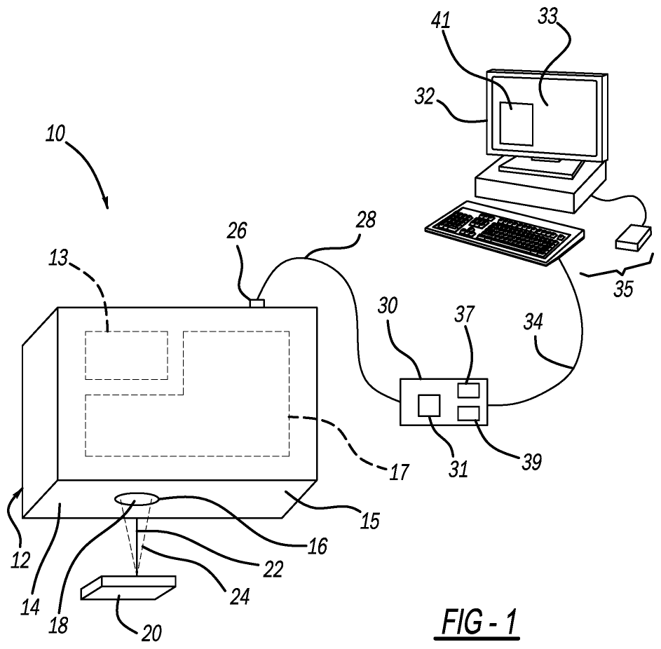

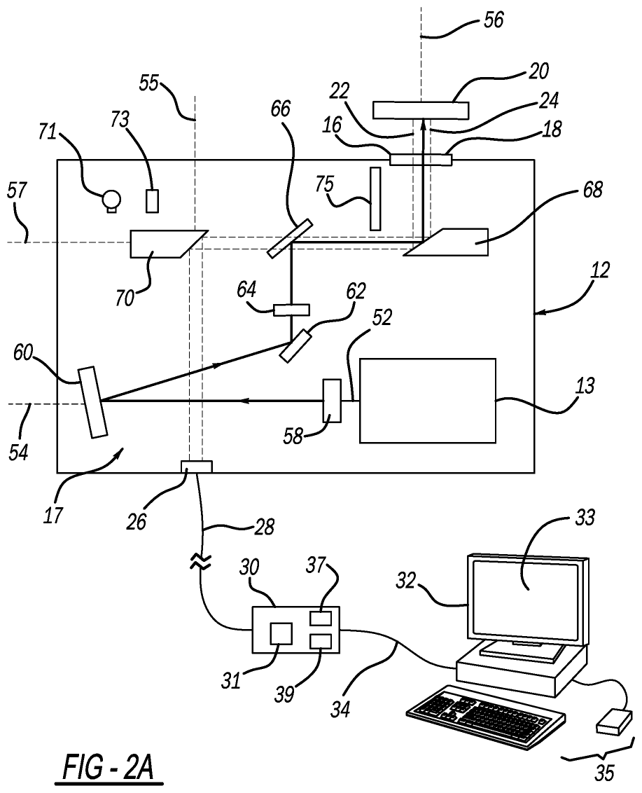

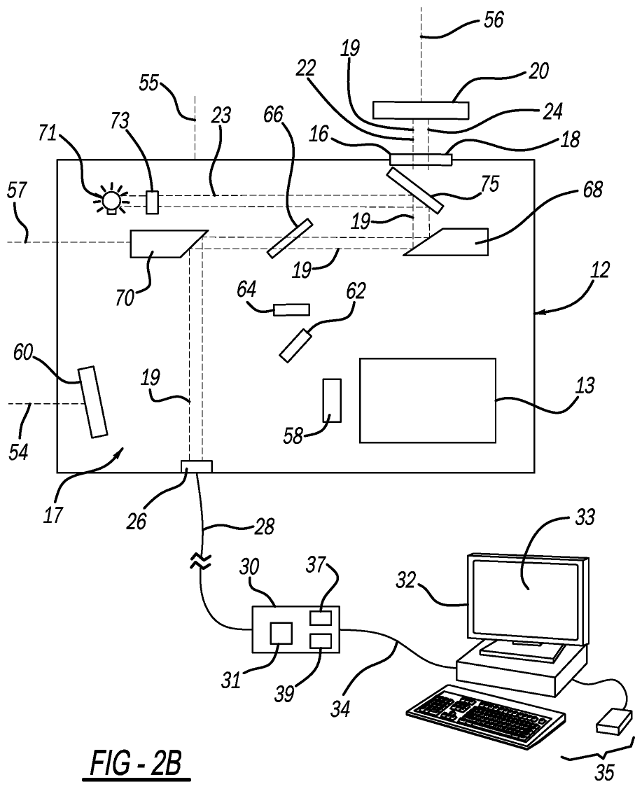

Referring to FIG. 1, a system 10 for analyzing the material composition of an object 20 by spectrum analysis is shown. As its primary component, the system 10 includes a device 12 for analyzing the material composition of the object 20. The device 12 may include a housing 14 which may enclose a number of components that will be described in FIG. 2 and later in this description. For example, the housing 14 may include a laser assembly 13 for producing a laser beam 22 and an optical assembly 17 for directing a laser beam 22 to the object 20. In addition, the optical assembly 17 may function to direct plasma emitted light 24 to a spectrometer sensor 31 of a spectrometer 30 via a light guide 28.

The device 12 has three primary functions. The device 12 provides beam shaping and delivery for the laser beam 22, efficiently collects the plasma emitted light 24 from the plasma for delivery to the spectrometer 30, and functions to calibrate the spectrometer and the spectrometer sensor 31. The laser beam 22 may be a single mode laser beam having a focused diameter of 20 to 50 micrometers on the object 20 in order to generate a strong plasma plume. The working distance may be around or greater than 10 mm.

A wall portion 15 of the housing 14 may have an opening 16 formed therein. The opening 16 may contain a window 18. The window 18 may be a transparent window allowing for the transmission of light to and from the device 12, such as the laser beam 22 and the plasma emitted light 24. The housing 14 may be hermetically sealed and may be filled with an inert gas.

As stated before, the device 12 is configured to emit a laser beam 22 towards the object 20. When the laser beam 22 strikes the object 20, a plasma plume is formed and plasma emitted light 24 is reflected back to the window 18. As will be described in more detail in FIG. 2, the plasma emitted light 24 is redirected to the spectrometer 30 via the light guide 28. The light guide 28 may be an optical fiber. The light guide adapter 26 optically directs the plasma emitted light 24 to the light guide 28. The light guide 28, in turn, directs the plasma emitted light 24 to a spectrometer 30.

The spectrometer 30 may perform a number of different spectral analyses of the plasma emitted light 24, and it converts these optical signals into electrical signals that may be provided to the digital analyzer and control system 32.

The spectrometer 30 may include a monochromator (scanning) or a polychromator (non-scanning) and a photomultiplier, CCD (charge coupled device) or CMOS detector, respectively. The spectrometer 30 may collect electromagnetic radiation over the widest wavelength range possible, maximizing the number of emission lines detected for each particular element. The response of the spectrometer 30 may be from 1100 nm (near infrared) to 170 nm (deep ultraviolet). For another application, the spectrometer 30 may collect electromagnetic radiation over a narrow wavelength range, maximizing the spectral line resolution of the sensor.

The spectrometer 30 may also include a temperature sensor 37 disposed within the housing of the spectrometer 30 that is configured to measure the temperature within the spectrometer 30. The spectrometer 30 may also include a motion detector 39 is configured to detect any forces acting upon the spectrometer 30. The motion detector 39 may be one or more accelerometers.

The electrical signals generated by the spectrometer 30 may be provided to the digital analyzer and control system 32 by a cable 34. These electrical signals generated by the spectrometer 30 may include the electrical signals indicating measurements taken by the spectrometer 30 but could also include temperature information from the temperature sensor 37 and/or motion detection from the motion detector 39. Additionally, it should be understood that any one of a number of different methodologies utilized to transmit analog signals or digital data from separate devices may be employed. For example, the digital analyzer and control system 32 may utilize a wireless protocol to communicate with the spectrometer 30. The digital analyzer and control system 32 may be a dedicated device having an output device 33 and one or more input devices 35. The output device 33 may be a display, while the input device 35 may be a keyboard and/or a mouse.

Referring to FIGS. 2A and 2B, a more detailed view of the device 12 is shown. FIG. 2A shows the device 12 in a measurement mode, while FIG. 2B shows the device 12 in a calibration mode. Like reference numerals have been utilized to refer to like elements.

Focusing on FIG. 2A, the device 12 may also include a laser assembly 13 for generating a laser beam 22 and an optical assembly 17 for directing the laser beam 22 to the object 20. In addition, the optical assembly 17 may direct the plasma emitted light 24 towards the light guide adapter 26. The laser assembly 13 may be an Nd:YAG laser that may generate energy pulses in the near-infrared region of the electromagnetic spectrum, with a wavelength of 1064 nm. The pulse duration may be in the order of 10 ns.

The laser assembly 13 is configured to output a laser beam 52. The laser beam 52 is directed along an axis 54 towards a mirror 60. From there, the laser beam 52 is directed from the mirror 60 to a second mirror 62. The second mirror 62 directs the laser to a dichroic mirror 66.

The dichroic mirror 66 has the ability to reflect light at one wavelength while allowing light at different wavelengths to pass through. Here, the dichroic mirror 66 may have a high reflectivity for the laser beam 52, which, as said previously, may be 1064 nm excitation light, and high transmission for the plasma emitted light 24, which may be in the ultraviolet region. The dichroic mirror 66 allows both excitation laser beam 52 and the collected plasma light 24 to be coaxial, which minimizes the component count and maximizes light capture efficiency.

The dichroic mirror 66 directs the laser beam 52 to a first aspheric mirror 68. The first aspheric mirror 68 directs the laser beam 52 (now laser beam 22) towards the object 20 along the axis 56. It is noted that the axis 54 and the axis 56 have different angles. The axis 54 and the axis 56 may have angles that are substantially perpendicular to one another. The laser beam 22 may be directed to the object 20 via the window 18. As the laser beam 22 strikes the object 20, plasma is generated.

The plasma emitted light 24 is then directed back to the first aspheric mirror 68 along the axis 56 along a primary optical path 19. The first aspheric mirror 68 redirects the plasma emitted light 24 along another axis 57 towards the dichroic mirror 66 along the primary optical path 19. As stated before, the dichroic mirror 66 is reflective for certain wavelengths of light but is transmissive at other wavelengths. Here, the plasma emitted light 24 has such a wavelength that it will substantially pass through the dichroic mirror 66 to a second aspheric mirror 70.

The second aspheric mirror 70 will direct the light along an axis 55 towards a light guide adapter 26. The light guide adapter 26 receives and focuses the light to a light guide 28 which then conveys this light to a spectral analyzer 30.

The optical assembly 17 may also include lenses 58 and 64. The lens 58 is generally located between the laser assembly 13 and the mirror 60. The lens 64 is generally located between the mirror 62 and the dichroic mirror 66. The lens 58 may have a positive or negative focal length, while the lens 64 will only have a positive focal length. Lenses 58 and 64 serve to the focus the laser beam 52 on the mirror 60 and the dichroic mirror 66, respectively.

The device 12 also includes a calibration light source 71. This calibration light source 71 can be a lamp configured to emit light with discrete and stable spectral lines. For example, this calibration light source may be a mercury vapor lamp that emits light with known discrete spectral lines. However, it should be understood that any type of light source may be utilized that is able to consistently output light with at least one known discrete and stable spectral line. The calibration light source 71 may be in communication with the digital analyzer and control system 32 so that the digital analyzer and control system can selectively activate or de-activate the calibration light source 71. When the calibration light source 71 is activated, the device 12 is essentially in a calibration mode and not in a normal operating measurement mode.

Referring to FIG. 2B, the device 12 is shown in a calibration mode. Here, the device 12 may also include a lens 73. The lens 73 is configured to direct and focus light received from the calibration light source 71 along a secondary optical path 23. Light from the calibration light source 71 that proceeds along secondary optical path 23 eventually comes into contact with a mirror 75. The mirror 75 may be a two-position mirror that includes a small electric motor that is in communication with the control system 32. As shown in FIG. 2A, this figure illustrates that the calibration light source 71 is not activated and that the mirror 75 is in a first position. This is essentially the normal measurement mode wherein the device 12 seeks to collect plasma emitted light 24 from an object 20. The mirror 75 essentially blocks any light that would have been provided along the secondary optical path 23 of FIG. 2B.

In FIG. 2B, the mirror 75 has been moved into a second position, which is indicative of a calibration mode. Here, the mirror 75 receives light generated from the calibration light source 71 that travels along the secondary optical path 23. This light is then reflected by the mirror 75 towards the first aspheric mirror 68. From there, this light proceeds along the primary optical path 19 towards the second aspheric mirror 70 and eventually to the light guide adapter 26 which then directs this light towards the spectrometer sensor 31 located within spectrometer 30. As such, the primary optical path 19 and the secondary optical path 23 are shown to overlap in this example. Of course, it is possible to arrange the components such that the primary optical path 19 and the secondary optical path 23 do not overlap. Since the energy of the calibration light 71 is typically orders of magnitude higher than the energy of the collected light beam 24, persons skilled in the art can design a calibrator using a less efficient but simpler secondary optical path that does not include movable optical components (like mirror 75).

When in this calibration mode shown in FIG. 2B, the spectrometer 30 and the spectrometer sensor 31 can essentially be calibrated, such that each pixel of the sensor 31 can be attributed a wavelength. As stated before, the calibration light source 71 emits light with discrete spectral lines which are detected by the sensor as separate, sharp peaks at specific pixel locations. Because the wavelengths of the discrete spectral lines are known, a conversion calibration equation (relationship) between pixels and wavelengths can be generated by the control system 32 which will enable readout of consecutive spectra in wavelength domain, thus making possible identification of elements by wavelengths of their characteristic emission lines. Should the spectrometer 30 and its sensor 31 experience change (for example due to thermal fluctuations or mechanical stress) which may affect its wavelength calibration, the control system 32 may anytime initiate a new calibration. Persons skilled in the art may design the device 10 in such a way to perform one calibration before each measurement, each n-th measurement, where n can be any number equal to or larger than 1, or, for example, whenever a temperature change, mechanical stress or recorded spectrum deterioration is detected. To these ends, the control system 32 may be configured to switch between a measurement mode and a calibration mode. When in the calibration mode, the control system 32 is configured to activate the calibration light source 71, measure a position of at least one known discrete spectral line of the calibration light source 71 on the spectrometer sensor 31, and recalculate assigned wavelength of at least one pixel.

Referring to FIGS. 1, 2A and 2B, having the calibration light source 71 within the housing 14 of device 12, persons skilled in the art can design system 10, device 12 and the algorithm of digital analyzer and control system 32 in such a way that the switching between the measurement and calibration mode may be performed by a user or may be automated and may not require any action from the operator or user of the device, making calibration faster and less susceptible to user-induced errors than spectrometer calibration with a light source that is external to the system 10 or device 12. The digital analyzer and control system 32 may also be configured to identify positions of the known discrete spectral lines of the calibration spectrum on the spectrometer sensor and recalculate and update a corresponding wavelength of at least one sensor pixel.

In addition, the digital analyzer and control system 32 may also include a real-time clock and a measurement counter. The digital analyzer and control system 32 may be configured to generate a log 41 covering a time interval of at least one measurement performed by the spectrometer 30. The log 71 may include a time from the real time clock at the time of the measurement for each of the at least one measurement performed by the spectrometer, a measurement count from the measurement counter at the time of the measurement for each of the at least one measurement performed by the spectrometer, a temperature from the temperature sensor 37 at the time of the measurement for each of the at least one measurement performed by the spectrometer, and acceleration data from the motion detector 39 at the time of the measurement for each of the at least one measurement performed by the spectrometer. The digital analyzer and control system 32 may be further configured to generate a metric for quantification of a quality of recently recorded spectra the at least one measurement performed by the spectrometer 30 based on information from the log 41.

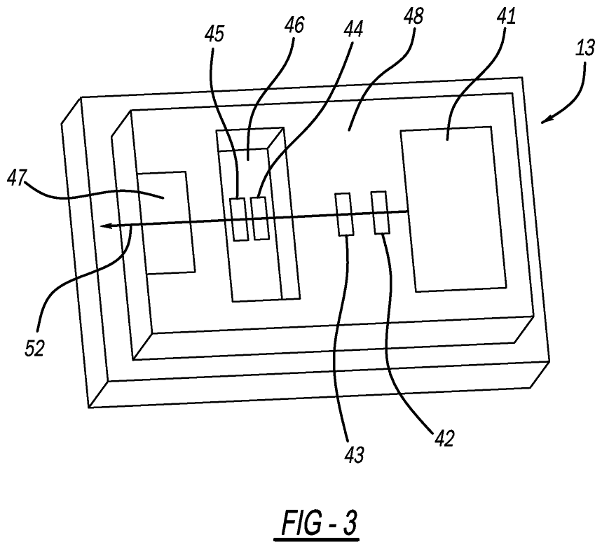

Referring to FIG. 3, a more detailed view of the laser assembly 13 is shown. The laser assembly 13 may be a diode-pumped solid-state laser. A diode laser pumps a solid gain medium, for example, a ruby or a neodymium-doped YAG crystal that stores the energy of the pumping laser light. This pumping may last, for example, 200-300 microseconds. When the stored energy in the gain medium reaches a certain level, the gain medium discharges the energy in a form of a very fast (for example, 20 ns long) burst of very high power.

As such, the laser assembly 13 includes a pump diode 41. Light emitted by the pump diode 41 is focused by lenses 42 and 43 onto the solid gain medium, laser crystal 44. A Q-switch 45 is placed on the side of the laser crystal, opposite to the pumping diode. The last element of the laser assembly 13 is an output coupler 47. The laser crystal 44, Q-switch 45 and the output coupler 47 may be stacked up as one module. The laser light leaving the output coupler 47 is aimed towards the lens 58 of FIG. 2. A resonator is essentially formed by the reflecting surfaces: input surface of the laser crystal 44 and the output surface of the Q-switch 45. The Q-switch 45 may be a passive Q-switch. Q switching is a technique for obtaining energetic short pulses from a laser by modulating the intracavity losses and thus the Q factor of the laser resonator. The technique is mainly applied for the generation of nanosecond pulses of high energy and peak power with solid-state bulk lasers.

As a person skilled in the art will readily appreciate, the above description is meant as an illustration of an implementation of the principles of this invention. This description is not intended to limit the scope or application of this invention in that the invention is susceptible to modification, variation, and change, without departing from the spirit of this invention, as defined in the following claims.

1. A device for analyzing a material composition of an object via plasma spectrum analysis and calibrating a spectrometer having a spectrometer sensor, the device comprising:
a laser assembly configured to emit a laser beam for plasma spectrum analysis;
an optical assembly configured to direct the laser beam towards a target for plasma spectrum analysis of the target;
a calibration light source configured to emit a light having known discrete spectral lines, the calibration light source being incorporated in the optical assembly;
wherein the optical assembly is configured to provide a primary optical path and a secondary optical path, the primary optical path directs light emitted from a plasma to the spectrometer, the secondary optical path directs light from the calibration light source to the spectrometer;
a housing, the housing substantially enclosing the laser assembly and the optical assembly; and
wherein the housing defines at least one opening configured to allow the laser beam to travel from the optical assembly to the target and to allow the plasma emitted light to be collected by the optical assembly.

2. The device for analyzing the material composition of an object via plasma spectrum analysis of claim 1, further comprising a control system being configured to switch between a measurement mode and a calibration mode, when in the calibration mode the control system is configured to activate the calibration light source and switch to the secondary optical path.

3. The device for analyzing the material composition of an object via plasma spectrum analysis of claim 2, wherein the control system is further configured to identify positions of the known discrete spectral lines of the calibration spectrum on the spectrometer sensor and recalculate and update a corresponding wavelength of at least one sensor pixel.

4. The device for analyzing the material composition of an object via plasma spectrum analysis of claim 2, wherein the control system is configured to change from the measurement mode to the calibration mode or from calibration mode to the measurement mode based upon commands from a user.

5. The device for analyzing the material composition of an object via plasma spectrum analysis of claim 2, wherein the control system is configured to automatically change from the measurement mode to the calibration mode or from calibration mode to the measurement mode based upon an output from an algorithm, without user interaction.

6. The device for analyzing the material composition of an object via plasma spectrum analysis of claim 2, further comprising:
a real-time clock;
a measurement counter;
a temperature sensor disposed within the spectrometer and configured to measure a temperature inside the spectrometer;
a motion detector configured to measure acceleration forces acting onto the spectrometer; and
wherein the control system is configured to generate a log covering a time interval of at least one measurement performed by the spectrometer, wherein the log includes a time from the real time clock at the time of the measurement for each of the at least one measurement performed by the spectrometer, a measurement count from the measurement counter at the time of the measurement for each of the at least one measurement performed by the spectrometer, a temperature from the temperature sensor at the time of the measurement for each of the at least one measurement performed by the spectrometer, and acceleration data from the motion detector at the time of the measurement for each of the at least one measurement performed by the spectrometer.

7. The device for analyzing the material composition of an object via plasma spectrum analysis of claim 6, wherein the control system is further to generate a metric for quantification of a quality of recently recorded spectra the at least one measurement performed by the spectrometer based on information from the log.

8. The device for analyzing the material composition of an object via plasma spectrum analysis of claim 1, wherein the calibration light source is a mercury vapor lamp or any lamp that emits a light that has stable spectral lines.

9. The device for analyzing the material composition of an object via plasma spectrum analysis of claim 1, further comprising at least one lens or mirror located within the housing and within the second optical path and configured to receive to direct light from the calibration light source to the spectrometer.

10. The device for analyzing the material composition of an object via plasma spectrum analysis of claim 1, wherein the primary optical path and the secondary optical path at least partially overlap.

11. The device for analyzing the material composition of an object via plasma spectrum analysis of claim 1, further comprising a mirror located within the housing and within the second optical path and configured to receive to direct light from the calibration light source to the spectrometer.

12. The device for analyzing the material composition of an object via plasma spectrum analysis of claim 11, wherein the mirror is a two-position mirror, when the mirror is in a first position light received by the mirror is directed toward the spectrometer, when the mirror is in a second position light received by the mirror is not provided to the spectrometer.

13. The device for analyzing the material composition of an object via plasma spectrum analysis of claim 12, further comprising a control system, the control system being configured to move the mirror from the first position to the second position when changing from a measurement mode to a calibration mode.

14. The device for analyzing the material composition of an object via plasma spectrum analysis of claim 13, wherein the control system is configured to move the mirror from the second position to the first position when changing from the calibration mode to the measurement mode.

15. The device for analyzing the material composition of an object via plasma spectrum analysis of claim 1, wherein the device is a portable or handheld device.

16. The device for analyzing the material composition of an object via plasma spectrum analysis of claim 1, wherein the laser assembly emits 1064 nm light.

17. The device for analyzing the material composition of an object via plasma spectrum analysis of claim 1, wherein the optical assembly further comprises:
a first aspheric mirror with an aspheric surface profile configured to receive a laser beam at non-normal incidence along a first axis;
the optical assembly being configured such that the aspheric mirror directs the beam to the object for plasma spectrum analysis along a second axis, the second axis being different from the first axis;
wherein the light emitted from the plasma is collected coaxially along the second axis and redirected along the first axis in the opposite direction by the first aspheric mirror; and
the optical assembly having a second aspheric mirror, the second aspheric mirror configured to redirect a portion of the plasma emitted light along a third axis, the second aspheric mirror having an aspheric surface profile.

18. The device for analyzing the material composition of an object via plasma spectrum analysis of claim 17, wherein the optical assembly further comprises:
a first mirror configured to receive the beam from the laser assembly, the beam from the laser assembly being projected along the first axis;
a second mirror, the first mirror being configured to direct the beam to the second mirror, the second mirror being configured to receive the beam from the first mirror;
a dichroic mirror, the second mirror being configured to direct the beam to the dichroic mirror, the dichroic mirror configured to receive the beam from the second mirror;
the first aspheric mirror configured to receive the beam from the dichroic mirror and direct the beam to the object along the second axis;
the second aspheric mirror configured to receive the plasma emitted light from the first aspheric mirror and direct the plasma emitted light to the spectrometer; and
the dichroic mirror being located substantially between the first aspheric mirror and the second aspheric mirror.

19. The device for analyzing the material composition of an object via plasma spectrum analysis of claim 18, wherein the optical assembly further comprises:
a first lens located between laser assembly and the first mirror, the first lens being configured to focus the beam from the laser assembly to the first mirror, the first lens having a positive or negative focal length; and
a second lens located between the second mirror and the dichroic mirror, the second lens being configured to focus the beam from the second mirror to the dichroic mirror, the second lens having a positive focal length.

20. The device for analyzing the material composition of an object via plasma spectrum analysis of claim 1, further comprising a light guide adapter, the light guide adapter being configured to receive the plasma emitted light emitted from a plasma or light from the calibration light source, the light guide adapter being in optical communication with the spectrometer and providing with the plasma emitted light or light from the calibration light source to the spectrometer.
